(19) United States
(12) Patent Application Publication
(10) Pub. No.: US 2013/0264277 A1
(43) Pub. Date: Oct. 10, 2013

(54) ANTIMICROBIAL FILTER

(71) Applicants: Erik HEIDENREICH, Pensacola, FL (US); Wilfrid Klaus Wixwat, Pensacola, FL (US); Richard Morris, Longwood, FL (US)

(72) Inventors: Erik HEIDENREICH, Pensacola, FL (US); Wilfrid Klaus Wixwat, Pensacola, FL (US); Richard Morris, Longwood, FL (US)

(73) Assignee: Pall Corporation, Port Washington, NY (US)

(21) Appl. No.: 13/438,897

(22) Filed: Apr. 4, 2012

(51) Int. Cl. B01D 24/00

(52) U.S. Cl. 210/508

(57) ABSTRACT

An antimicrobial filter is disclosed comprising at least two porous media: a first porous medium including silver particles in the bulk of the medium, disposed on a second porous medium suitable for capturing silver particles leached from the first medium.

### BACKGROUND OF THE INVENTION

Microorganisms such as bacteria can contaminate a variety of fluids. While membranes can be used to filter the fluids and remove the bacteria (e.g., to provide potable water), the bacteria accumulating on the surfaces of the membranes grow quickly and create biofilms, leading to fouling and blocking of the membranes.

Conventional membranes for treating microorganism-contaminated fluids have suffered from a variety of deficiencies, including the expense associated with producing such membranes.

The present invention provides for ameliorating at least some of the disadvantages of the prior art. These and other advantages of the present invention will be apparent from the description as set forth below.

### BRIEF SUMMARY OF THE INVENTION

An embodiment of the invention provides an antimicrobial porous filter comprising at least two layers: a first porous medium including silver particles in the bulk of the medium, disposed on a second porous medium having a particle-capturing pore structure. The second porous medium captures particles leached from the first porous medium. Porous media can comprise membranes and/or fibrous media. For example, the antimicrobial porous filter can comprise at least two porous membranes, at least two porous fibrous media, or at least one porous membrane and at least one porous fibrous medium. In some embodiments the first porous medium comprises a porous fibrous medium, preferably, the fibrous medium comprises a non-woven fibrous medium.

Another embodiment of the invention provides an antimicrobial filter comprising at least two layers: a first porous membrane including silver particles in the bulk of the membrane, disposed on a second porous membrane having a particle-capturing pore structure. The second porous membrane captures particles leached from the first porous membrane.

Preferably, in those embodiments wherein the filter comprises at least one membrane, at least one of the membranes comprises polysulfone, more preferably, the first and second membranes comprise polyethersulfone.

In accordance with antimicrobial filters according to the invention, at least one membrane can comprise an asymmetric membrane or comprise an isometric membrane.

In another embodiment of the invention, a method for treating a fluid, more preferably, a method for filtering a fluid, comprises passing the fluid through an embodiment of the antimicrobial filter.

### DETAILED DESCRIPTION OF THE INVENTION

In accordance with an embodiment of the present invention, an antimicrobial filter is provided comprising (a) a first porous medium having an upstream surface and a downstream surface and a bulk between the upstream and downstream surfaces, the first porous medium including particles comprising silver in the bulk, the particles having an average diameter in the range of from about 0.2 micrometers to about 20 micrometers; and (b) a second porous medium having an upstream surface and a downstream surface and a bulk between the upstream and downstream surfaces, the second porous medium having a mean flow pore (MFP) size less than the average diameter of the particles in the first layer; wherein the downstream surface of the first porous medium contacts the upstream surface of the second porous medium. Typically, the second porous medium comprises a membrane.

In accordance with another embodiment of the present invention, an antimicrobial filter is provided comprising (a) a first microporous sulfone membrane having an upstream surface and a downstream surface and a bulk between the upstream and downstream surfaces, the first membrane including particles comprising silver in the bulk, the particles having an average diameter in the range of from about 0.2 micrometers to about 20 micrometers; and (b) a second microporous membrane having an upstream surface and a downstream surface and a bulk between the upstream and downstream surfaces, the second membrane having a mean flow pore (MFP) size less than the average diameter of the particles in the first membrane; wherein the downstream surface of the first membrane contacts the upstream surface of the second membrane.

In accordance with yet another embodiment of the present invention, an antimicrobial filter is provided comprising (a) a fibrous porous medium having an upstream surface and a downstream surface and a bulk between the upstream and downstream surfaces, the fibrous porous medium including particles comprising silver in the bulk, the particles having an average diameter in the range of from about 0.2 micrometers to about 20 micrometers; and (b) a porous membrane having an upstream surface and a downstream surface and a bulk between the upstream and downstream surfaces, the porous membrane having a mean flow pore (MFP) size less than the average diameter of the particles in the fibrous medium; wherein the downstream surface of the fibrous medium contacts the upstream surface of the porous membrane. In a preferred embodiment, the fibrous porous medium comprises a non-woven fibrous porous medium.

Typically, at least one membrane comprises a sulfone membrane, more typically, in those embodiments wherein the filter comprises at least first and second membranes, the first and second membranes each comprise a sulfone membrane, and preferably, the first and second sulfone membranes each comprise polysulfone membranes. In an even more preferred embodiment, the first and second sulfone membranes each comprise polyethersulfone membranes.

Desirably, the filter is an integral multilayer filter, i.e., the membranes or fibrous medium and membrane are bonded together such that the filter behaves as a single structure that does not delaminate or separate under normal use conditions.

Filters comprising porous fibrous media and/or porous membranes according to embodiments of the invention can be used in a variety of applications, including, for example, sterile filtration applications, filtering fluids for the pharmaceutical industry, filtering fluids for medical applications (including for home and/or for patient use, e.g., intravenous applications), filtering fluids for the electronics industry, filtering fluids for the food and beverage industry, clarification, filtering antibody- and/or protein-containing fluids, and/or filtering cell culture fluids. Alternatively, or additionally, filters according to embodiments of the invention can be used to filter air and/or gas and/or can be used for venting applications (e.g., allowing air and/or gas, but not liquid, to pass therethrough). Filters according to embodiments of the inventions can be used in a variety of devices, including surgical devices and products, such as, for example, ophthalmic surgical products. Filters according to embodiments of the invention are also suitable for use with any water supply system in, for example, hospitals, public areas, hotels, and households. This can be especially desirable, as contamination of water dispensed to a person who may be vulnerable to infection can lead to, for example, debilitating and costly infections, even morbidity

In accordance with embodiments of the invention, “antimicrobial” encompasses killing microbes (“microcidal”) and inhibiting the growth and/or reproduction of microbes (“microbiostatic”). The term “microbe” includes bacteria, viruses, fungi, and protozoa.

Advantageously, filters comprising fibrous media and/or membranes can be tailored for particularly applications, e.g., the amount of silver in the fibrous medium and/or membrane can be adjusted; for example, less silver may be used for membranes treating fluid having low levels of contamination. Alternatively, or additionally, less total silver can be used in contrast to conventional membranes, as there is no need to disperse the silver throughout the thickness of the entire membrane; in accordance with the invention the silver is provided in a single membrane or fibrous layer.

The fibrous porous medium (e.g., a web such as woven web or a non-woven web; or a wet-laid medium) or porous membrane can be made of any suitable material; preferably, the fibrous medium or membrane comprises a polymeric medium. A variety of polymers are suitable, and suitable fibrous porous media and porous membranes can be prepared by methods known to those of ordinary skill in the art.

A variety of forms of silver can be used, including elemental silver, silver zeolite, and silver/zinc zeolite.

A variety of particle sizes are suitable for use in the invention. Typically, the particles have an average diameter of about 30 micrometers (μm) or less. In a preferred embodiment, the particles comprising silver in the first membrane layer or the fibrous medium have an average diameter in the range of from about 0.3 μm to about 20 μm, more preferably, in the range of from about 0.3 μm to about 10 μm, even more preferably, the particles comprising silver in the first membrane layer or fibrous medium have an average diameter in the range of from about 0.5 μm to about 3 μm.

The particles may comprise polyvinylpyrrolidone (PVP) in addition to silver (e.g., wherein the silver complexes with the PVP). Without being bound to any particular mechanism, it is believed that in some embodiments, the PVP complexes with the silver for better suspension in the membrane layer or the fibrous medium and/or the PVP prevents the formation of large agglomerations of silver.

A variety of silver concentrations are suitable for use in the invention, and as noted above, the amount of silver in the membrane can be tailored for an application. Illustratively, in some embodiments wherein the membrane layer comprising silver particles (e.g., elemental silver, silver zeolite, or silver/zinc zeolite) comprises a polysulfone membrane (preferably, a polyethersulfone membrane), the silver concentration is at least about 0.3% m (silver, e.g., elemental Ag, Ag zeolite, or Ag/zinc zeolite)/m polysulfone or polyethersulfone, more typically, the silver concentration is at least about 0.8% m (elemental Ag, Ag zeolite, or Ag/zinc zeolite)/m polysulfone or polyethersulfone. In some embodiments, the silver concentration is in the range of from about 0.5% m (elemental Ag, Ag zeolite, or Ag/zinc zeolite)/m polysulfone or polyethersulfone to about 1% m (elemental Ag or Ag/zinc zeolite)/m polysulfone or polyethersulfone. Similarly, in some embodiments wherein the fibrous medium comprising silver particles (e.g., elemental silver, silver zeolite, or silver/zinc zeolite) comprises a polymeric fibrous medium (e.g., a polyester such as polybutylene terephthalate (PBT), polyethylene terephthalate, (PET); or a polyolefin such as polypropylene), the silver concentration is at least about 0.3% m (silver, e.g., elemental Ag, Ag zeolite, or Ag/zinc zeolite)/m polymer (e.g., PBT, PET, or polypropylene), more typically, the silver concentration is at least about 0.8% m (elemental Ag, Ag zeolite, or Ag/zinc zeolite)/m polymer. In some embodiments, the silver concentration is in the range of from about 0.5% m (elemental Ag, Ag zeolite, or Ag/zinc zeolite)/m polymer to about 1% m (elemental Ag or Ag/zinc zeolite)/m polymer.

The porous media (e.g., fibrous media or membranes) are disposed upon one another such that the downstream surface of the first porous fibrous medium/membrane contacts the upstream surface of the second porous medium. The downstream surface of the first porous fibrous medium/membrane is preferably bound to the upstream surface of the second porous medium.

Preferably, in the embodiments of the filters comprising membranes, the filter comprises at least two membranes that are cast one on the other, wherein the membranes are prepared by a phase inversion process. In some embodiments including a membrane and a fibrous medium, the membrane is cast on the fibrous medium, and the membrane is prepared by a phase inversion process. Typically, the phase inversion process involves casting or extruding polymer solutions into thin films, and precipitating the polymers through one or more of the following: (a) evaporation of the solvent and nonsolvent, (b) exposure to a non-solvent vapor, such as water vapor, which absorbs on the exposed surface, (c) quenching in a non-solvent liquid (e.g., a phase immersion bath containing water, and/or another non-solvent), and (d) thermally quenching a hot film so that the solubility of the polymer is suddenly greatly reduced. Phase inversion can be induced by the wet process (immersion precipitation), vapor induced phase separation (VIPS), thermally induced phase separation (TIPS), quenching, dry-wet casting, and solvent evaporation (dry casting). Dry phase inversion differs from the wet or dry-wet procedure by the absence of immersion coagulation. In these techniques, an initially homogeneous polymer solution becomes thermodynamically unstable due to different external effects, and induces phase separation into a polymer lean phase and a polymer rich phase. The polymer rich phase forms the matrix of the membrane, and the polymer lean phase, having increased levels of solvents and non-solvents, forms the pores.

Preferably, the first solution is spread in a layer onto a support, and the second solution is spread in a layer onto the first solution, and the membrane can be later separated from the support after quenching. In some embodiments wherein the filter comprises more than two membranes, e.g., wherein a membrane comprising silver is arranged between other membranes, the solutions can be spread on each other in the desired order.

The membranes can be cast manually (e.g., poured, cast, or spread by hand onto a casting surface and quench liquid applied onto the surface) or automatically (e.g., poured or otherwise cast onto a moving bed). Examples of suitable supports include, for example, polyethylene coated paper, or polyester (such as MYLAR).

A variety of casting techniques, including dual casting techniques, are known in the art and are suitable. A variety of devices known in the art can be used for casting. Suitable devices include, for example, mechanical spreaders, that comprise spreading knives, doctor blades, or spray/pressurized systems. One example of a spreading device is an extrusion die or slot coater, comprising a casting chamber into which the casting formulation (solution comprising a polymer) can be introduced and forced out under pressure through a narrow slot. Illustratively, the first and second solutions comprising polymers can be separately cast by means of a doctor blade with knife gaps in the range from about 120 micrometers to about 500 micrometers, more typically in the range from about 180 micrometers to about 400 micrometers. The knife gaps can be different for the first and second solutions.

A variety of air gaps are suitable for use in the invention, and the air gaps can be the same for the same for the knives/doctor blades, or different. Typically, the air gaps are in the range of from about 3 inches to about 80 inches.

A variety of casting speeds are suitable as is known in the art. Typically, the casting speed is at least about 2 feet per minute (fpm), e.g., with knife air gaps of at least about 3 inches.

A variety of polymers and polymer solutions are suitable for use in the invention, and are known in the art. Suitable polymer solutions can include, polymers such as, for example, polyaromatics; sulfones (e.g., polysulfones, including aromatic polysulfones such as, for example, polyethersulfone, polyether ether sulfone, bisphenol A polysulfone, polyarylsulfone, and polyphenylsulfone), polyamides, polyimides, polyvinylidene halides (including polyvinylidene fluoride (PVDF)), polyolefins, such as polypropylene and polymethylpentene, polyesters, polystyrenes, polycarbonates, polyacrylonitriles (including polyalkylacrylonitriles), cellulosic polymers (such as cellulose acetates and cellulose nitrates), fluoropolymers, and polyetherether ketone (PEEK). Polymer solutions can include a mixture of polymers, e.g., a hydrophobic polymer (e.g., a sulfone polymer) and a hydrophilic polymer (e.g., polyvinylpyrrolidone). Preferred polymers for porous fibrous media include synthetic polymeric materials, for example, polybutylene terephthalate (PBT), polyethylene, polyethylene terephthalate (PET), polypropylene, polymethylpentene, polyvinylidene fluoride, polysulfone, polyethersulfone, nylon 6, nylon 66, nylon 6T, nylon 612, nylon 11, and nylon 6 copolymers.

In addition to one or more polymers, typical polymer solutions comprise at least one solvent, and may further comprise at least one non-solvent. Suitable solvents include, for example, dimethyl formamide (DMF); N,N-dimethylacetamide (DMAC); N-methyl pyrrolidone (NMP); tetramethylurea; dioxane; diethyl succinate; dimethylsulfoxide; chloroform; and tetrachloroethane; and mixtures thereof. Suitable nonsolvents include, for example, water; various polyethylene glycols (PEGs; e.g., PEG-400, PEG-1000); polypropylene glycols, various alcohols, e.g., methanol, ethanol, isopropyl alcohol (IPA), amyl alcohols, hexanols, heptanols, and octanols; alkanes, such as hexane, propane, nitropropane, heptanes, and octane; and ketone, ethers and esters such as acetone, butyl ether, ethyl acetate, and amyl acetate; and various salts, such as calcium chloride, magnesium chloride, and lithium chloride; and mixtures thereof.

If desired, a solution comprising a polymer can further comprise, for example, one or more polymerization initiators (e.g., any one or more of peroxides, ammonium persulfate, aliphatic azo compounds (e.g., 2,2′-azobis(2-amidinopropane) dihydrochloride (V50)), and combinations thereof), and/or minor ingredients such as surfactants and/or release agents.

Suitable components of solutions and methods of preparing membranes are known in the art. Illustrative solutions comprising polymers, and illustrative solvents and nonsolvents, and methods of preparing membranes include those disclosed in, for example, U.S. Pat. Nos. 4,340,579; 4,629,563; 4,900,449; 4,964,990, 5,444,097; 5,846,422; 5,906,742; 5,928,774; 6,045,899; 6,146,747; and 7,208,200.

In accordance with the invention, layers of the membrane can be formed from the same polymer and solvent, varying the viscosity, additives, and treatment, or different polymers can be used for different layers.

The porous fibrous media and membranes can have any suitable pore structure, e.g., a pore size (for example, as evidenced by bubble point, or by K_{L} as described in, for example, U.S. Pat. No. 4,340,479, or evidenced by capillary condensation flow porometry), a mean flow pore (MFP) size (e.g., when characterized using a porometer, for example, a Porvair Porometer (Porvair plc, Norfolk, UK), or a porometer available under the trademark POROLUX (Porometer.com; Belgium)), a pore rating, a pore diameter (e.g., when characterized using the modified OSU F2 test as described in, for example, U.S. Pat. No. 4,925,572), or removal rating that reduces or allows the passage therethrough of one or more materials of interest as the fluid is passed through the porous media. The pore structure used depends on the size of the particles to be utilized, the composition of the fluid to be treated, and the desired effluent level of the treated fluid.

Typically, at least one membrane has a MFP size in the range in the range of from about 0.1 μm to about 1 μm. However, larger and smaller pore structures are also encompassed by embodiments of the invention.

Typically, at least one fibrous medium has a mean pore size in the range of from about 0.5 μm to about 100 μm, preferably, in the range of from about 0.5 μm to about 10 μm. However, larger and smaller pore structures are also encompassed by embodiments of the invention.

Typically, at least one fibrous medium has a basis weight in the range of from about 1 g/M² to about 1000 g/M², more typically, in the range of from about 10 g/M² to about 100 g/M².

In some embodiments, at least one membrane (e.g., downstream of a fibrous medium or a membrane comprising the silver particles) has a sterilizing grade pore structure, e.g., an MFP size of about 0.2 μm, or less. However, larger and smaller pore structures are also encompassed by embodiments of the invention. For example, in some other embodiments, at least one membrane (e.g., downstream of the porous medium comprising the silver particles) has a MFP size of about 0.45 μm, or about 0.8 μm.

Embodiments of the invention can include at least one asymmetric membrane, at least one isometric membrane, two or more membranes of the same type of pore structure, or a combination of both asymmetric and isometric membranes.

An isometric membrane has a porous structure with a distribution characterized by a pore structure (e.g., a mean pore size) that is substantially the same through the bulk of the membrane. For example, with respect to mean pore size, an isometric membrane has a pore size distribution characterized by a mean pore size that is substantially the same through the membrane.

An asymmetric membrane has a pore structure (e.g., a mean pore size) varying throughout the bulk of the membrane. For example, the mean pore size decreases in size from one portion or surface to another portion or surface (e.g., the mean pore size decreases from the upstream portion or surface to the downstream portion or surface). However, other types of asymmetry are encompassed by embodiments of the invention, e.g., the pore size goes through a minimum pore size at a position within the thickness of the asymmetric membrane. The asymmetric membrane can have any suitable pore size gradient or ratio. This asymmetry can be measured by, for example, comparing the mean pore size on one major surface of a membrane with the mean pore size of the other major surface of the membrane.

The fibrous medium and/or membrane can have any suitable thickness. In some embodiments, the thickness of the membrane comprising silver is less than the thickness of each of one or more membranes not comprising silver. For example, in some embodiments comprising a first membrane comprising silver and a second membrane not comprising silver, the thickness of the first membrane is about 50% or less than the thickness of the second membrane, or about 40% or less than the thickness of the second membrane. Typically, a membrane comprising silver has a thickness in the range of from about 1 to about 3.5 mils, and a membrane without silver has a thickness in the range of from about 2.5 to about 5.5 mils.

Typically, the fibrous medium has a thickness in the range of from about 2 to about 15 μm, but thicknesses can be less than, or greater than, this range.

The membranes and fibrous media can have any desired critical wetting surface tension (CWST, as defined in, for example, U.S. Pat. No. 4,925,572). The CWST can be selected as is known in the art, e.g., as additionally disclosed in, for example, U.S. Pat. Nos. 5,152,905, 5,443,743, 5,472,621, and 6,074,869. For applications wherein liquid passes through the membrane and/or fibrous medium, the membrane and fibrous medium are typically hydrophilic, having a CWST of 72 dynes/cm (72×10⁻⁵ N/cm) or more, more typically about 85 dynes/cm (about 85×10⁻⁵N/cm) or more. However, for some other application wherein liquid does not pass through the membrane or fibrous medium (e.g., for venting applications), the membrane and/or fibrous medium can be hydrophobic, having a CWST of less than 72 dynes/cm (72×10−5 N/cm).

The surface characteristics of the membranes and fibrous media can be modified (e.g., to affect the CWST, to include a surface charge, e.g., a positive or negative charge, and/or to alter the polarity or hydrophilicity of the surface) by wet or dry oxidation, by coating or depositing a polymer on the surface, or by a grafting reaction. Modifications include, e.g., irradiation, a polar or charged monomer, coating and/or curing the surface with a charged polymer, and carrying out chemical modification to attach functional groups on the surface. Grafting reactions may be activated by exposure to an energy source such as gas plasma, vapor plasma, corona discharge, heat, a Van der Graff generator, ultraviolet light, electron beam, or to various other forms of radiation, or by surface etching or deposition using a plasma treatment.

Exemplary membranes are disclosed in U.S. Pat. Nos. 4,702,840 and 4,900,449. Other membranes, including those disclosed in U.S. Pat. Nos. 4,906,374; 4,886,836; 4,964,989; 5,019,260; 4,340,479; 4,855,163; 4,744,132; 4,707,266; 4,203,848; 4,618,533, 6,039,872; 6,780,327; 6,783,937; and 7,189,322, may also be suitable.

Exemplary fibrous media (including melt-blown non-woven media) are disclosed in U.S. Pat. Nos. 4,880,548; 4,925,572, 5,152,905, and 6,074,869.

A filter according to an embodiment of the invention can include additional elements, layers, or components, that can have different structures and/or functions, e.g., at least one of prefiltration, support, drainage, spacing and cushioning. Illustratively, an embodiment of the filter can also include at least one additional element such as a mesh and/or a screen.

In accordance with embodiments of the invention, the filter can have a variety of configurations, including planar, pleated, and hollow cylindrical.

A variety of embodiments of devices (comprising an embodiment of the filter) are encompassed by the invention, including, for example, dropper bottles, dropper tips, and syringe filters, capsule filters, and cartridges.

An embodiment of the filter according to the invention is typically disposed in a housing comprising at least one inlet and at least one outlet and defining at least one fluid flow path between the inlet and the outlet, wherein the filter is across the fluid flow path, to provide a filter device. Preferably, the filter device is sterilizable. Any housing of suitable shape and providing at least one inlet and at least one outlet may be employed.

The following examples further illustrate the invention but, of course, should not be construed as in any way limiting its scope.

In the following examples, filters including two and three membranes are prepared by phase inversion, using casting solutions with and without silver particles.

With the exception of the asymmetric membrane described in Example 3, each solution includes about 65% polyethylene glycol (E400); about 1% glycerin; about 11% polyethersulfone; about 10% DMF; about 8% NMP; about 3% DI water; about 0.01% phosphoric acid; about 0.9% polyvinylpyrrolidone. The solution including silver particles includes about 0.9% elemental silver particles about 1-3 μm in diameter.

With respect to the asymmetric membrane described in Example 3, the solution includes about 59% polyethylene glycol (E400); about 1% glycerin; about 13% polyethersulfone; about 14% DMF; about 10% NMP; about 3% RO water; about 0.6% polyvinylpyrrolidone, and about 1% elemental silver particles about 1-3 μm in diameter.

To prepare the two membrane filters, a solution without silver is cast over a solution with silver. To prepare the three membrane filters, a solution without silver is cast first, followed by casting a solution with silver, followed by casting a solution without silver.

In preparing a two membrane filter, a silver particle containing solution (a first solution) is cast on a plate having a temperature of about 29° C. using a first knife having a knife gap of 10 mils. A silver particle free solution (a second solution) is continuously cast on the first solution using a second knife located about 0.5 inches to about 1.5 inches from the first knife, the second knife having a knife gap of 22 mils.

In preparing a three membrane filter, a silver free solution (a first solution) is cast on a plate having a temperature of about 29° C. using a first knife having a knife gap of 10 mils. A silver particle containing solution (a second solution) is continuously cast on the first solution using a second knife located about 0.5 inches to about 1.5 inches from the first knife, the second knife having a knife gap of 14 mils. Another silver free solution (a third solution, identical to the first solution) is continuously cast on the second solution using a third knife located about 0.5 to about 1.5 inches from the second knife, the third knife having a knife gap of 22 mils.

The knives are pushed to cast along the plate at a speed of about 1 inch per second. Once the membranes are cast, the plate is transferred to a chamber, where the temperature is maintained at 26.7° C. at a relative humidity of 71%, with fans providing an air velocity of 5 ft/sec for 10 minutes until the membranes form.

Water bubble point measurements of membranes indicate the isotropic membranes have a 0.2 μm MFP size, and the asymmetric membranes have a 0.8 0.2 μm MFP size.

Membranes are tested for antimicrobial activity against Escherichia coli (E. coli). E. coli ATCC 11229 is the challenge organism, used in inoculation volumes of 0.1 ml. Membrane samples are placed in sterilized vacuum funnels, wetted with sterile rinse solution, the appropriate volume of challenge solution is applied, and vacuum is applied. The samples are plated on growth medium, and colonies are counted.

SEM analysis shows no silver particles are present on the downstream side of the downstream membrane.

### Example 1

This example demonstrates a two membrane filter including silver in the first membrane according to an embodiment of the invention prevents bacterial growth.

A two membrane filter is prepared as described above, wherein the upstream membrane includes silver, and both membranes are isotropic membranes. The membranes with silver (and the unchallenged controls) show little or no bacterial growth, and the challenged controls show significant bacterial growth.

### Example 2

This example demonstrates a three membrane filter including silver in the middle membrane according to an embodiment of the invention prevents bacterial growth.

A three membrane filter is prepared as described above, wherein the middle membrane includes silver, and all three membranes are isotropic membranes. The membranes with silver (and the unchallenged controls) show little or no bacterial growth, and the challenged controls show significant bacterial growth.

### Example 3

This example demonstrates that a two membrane filter wherein the first membrane (containing silver) is an asymmetric membrane according to an embodiment of the invention prevents bacterial growth.

A two membrane filter is prepared as described above, wherein the upstream membrane includes silver, and is an asymmetric membrane, and the downstream membrane is an isotropic membrane. The membranes with silver (and the unchallenged controls) show little or no bacterial growth, and the challenged controls show significant bacterial growth.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An antimicrobial porous filter comprising:
(a) a first porous medium having an upstream surface and a downstream surface and a bulk between the upstream and downstream surfaces, the first porous medium including particles comprising silver in the bulk, the particles having an average diameter in the range of from about 0.2 micrometers to about 20 micrometers; and
(b) a second porous medium having an upstream surface and a downstream surface and a bulk between the upstream and downstream surfaces, the second porous medium having a mean flow pore (MFP) size less than the average diameter of the particles in the first layer; wherein the downstream surface of the first porous medium contacts the upstream surface of the second porous medium.

2. The antimicrobial filter of claim 1, wherein
(a) the first porous medium comprises a first microporous sulfone membrane; and
(b) the second porous medium comprises a second microporous membrane;
wherein the downstream surface of the first membrane contacts the upstream surface of the second membrane.

3. The antimicrobial filter of claim 2, wherein the first membrane has a thickness that is about 50% or less than the thickness of the second membrane.

4. The filter of claim 1, wherein the particles further comprise polyvinylpyrrolidone.

5. The filter of claim 2, further comprising a third membrane, upstream of the first membrane.

6. The filter of claim 2, wherein at least the first sulfone membrane comprises a polyethersulfone membrane.

7. The filter of claim 1, wherein the second porous medium comprises a microporous sulfone membrane.

8. The filter of claim 6, wherein the polyethersulfone membrane includes a silver concentration of at least about 0.3% m silver/m polyethersulfone.

9. The filter of claim 1, wherein the particles have an average diameter in the range of from about 0.5 to about 3 micrometers.

10. The filter of claim 1, wherein the first porous medium or membrane comprises an asymmetric membrane.

11. The filter of claim 1, wherein the first porous medium or membrane comprises an isotropic membrane.

12. The filter of claim 2, wherein the first and second membranes each comprise an isotropic membrane.

13. The filter of claim 2, wherein the first membrane comprises an asymmetric membrane and the second membrane comprises an isotropic membrane.

14. The filter of claim 1, wherein the first porous medium and/or the second porous medium has a mean pore size in the range of about 0.1 to about 0.5 micrometers.

15. The filter of claim 1, wherein the first porous medium comprises a fibrous medium.

16. The filter of claim 15, wherein the fibrous medium comprises a melt-blown medium.

17. The filter of claim 16, wherein the fibrous medium comprises a polymeric medium, and wherein the fibrous medium includes a silver concentration of at least about 0.3% m silver/m polymer.

18. A method of treating a fluid comprising:
passing the fluid through the filter of claim 1.

19. The filter of claim 2, wherein the particles further comprise polyvinylpyrrolidone.

20. The filter of claim 15, wherein the particles further comprise polyvinylpyrrolidone.
